(19) United States
(12) Patent Application Publication
(10) Pub. No.: US 2004/0083148 A1
(43) Pub. Date: Apr. 29, 2004

(54) Software computer application program product whose process, method and system refers, screens, matchs, approves, tracks and transfers prospective potential clients trusts, estates, investment management and other traditional trust products and service accounts whose invention is directed to trust vendors, independent trust companies, state and federal bank trust departments and other financial institutions and professionals

(75) Inventor: Mitchell E. Chadrow, North Wales, PA (US)

Correspondence Address: Mitchell E. Chadrow, President, C/o VirtualCash, Inc., P.O. Box 611, Bensalem, PA, 19020, US

(73) Assignee: VirtualCash, Inc., Bensalem, PA

(21) Appl. No.: 10/435,833

(22) Filed: May 12, 2003

Related U.S. Application Data
(60) Provisional application No. 60/379,786, filed on May 13, 2002.

(51) Int. Cl. G06F 17/60

(52) U.S. Cl. 705/35

(57) ABSTRACT

The present invention is directed to a process or method for Trust Vendors, Independent Trust Companies, State and Federal Bank Trust Departments and other financial institutions. The system includes the steps of: matching a potential prospect and or trust vendor with a financial institution for trust, estate and investment management products or services and other traditional trust services and products through a website; company, individual, professional organization or entity that referred business is tracked; prospective client fills out a contact form and background information; matching predetermined criteria is supplied by financial institution/other potential client and prospective/potential client, respectively, to match each party, up to five matches are determined and then each party is electronically notified that a match has occurred; financial institution reviews the contact form and background information supplied by prospective client; an approval form is then filled out with greater detailed information sent electronically to financial institution; trust agreement terms and conditions as well as transfer documents are analyzed information electronically sent to checklists used as part of the account opening policies and procedures regulatory process for a potential client trust committee to accept, if financial institutions agrees to accept business and prospective client wants to open account with financial institution additional information is obtained; the additional information is electronically sent to an Account Open Form. Individual, Company or Professional Organization or “Party” that referred business is notified that an account agreement or trust agreement has been signed by prospective client; referring party receives monthly, quarterly or flat fee based on type of account or assets referred or nature of relationship; process, method or system tracks the dollar amount of fee that will be received by referring party and makes sure that payment is made; further facilitate the account opening process and system by tracking the transfer of assets into the account.

### FIELD OF THE INVENTION

The present invention is directed to a prospective or potential trust client or other potential client, entity, traditional trust company client, or financial institution or dealing with trust vendor products or services e.g. trustors, trustees, executors, investment management clients, power of attorney, professionals that work with these prospective clients like (accountants, attorney's, advisors, etc.) or financial institutions to facilitate the matching, tracking, referring and opening of trusts, estates and investment management accounts with Independent Trust Companies, State and Federal Trust Banks and other financial institutions.

### BACKGROUND OF THE INVENTION

Trustors, trustees, executors, investment management clients, powers of attorney and other professional team members like accountants, lawyers, advisors need a way to evaluate, analyze and synthesize the various financial institutions that provide trusts, estates and investment management and other traditional trust company products and services or as it relates to financial institutions seeking trust vendor products or services. These same individuals need a way to more efficiently analyze trust documents and terms facilitate the transfer of assets and fill out checklists and other account opening forms that are driven by compliance and regulatory authorities. These individuals or prospective trust clients were required to seek out trust companies by physically traveling to each institution, gathering background information on these companies, people, performance and investment style, philosophy and processes, sometimes through several meetings over long periods of time or if referring to financial institutions seeking trust vendors the need to obtain information regarding pricing of products and services, negotiating with trust vendor for contracts. As well, financial institutions would have to meet with prospective clients possibly several times, gather information, fill out forms, approve and track referrals in a manual process. These procedures and processes have been time consuming, cumbersome and unwieldy. It is time consuming because each financial institution and prospective trust client might have different or similar criteria to determine a relationship. The prospective client, therefore, may have to visit or travel to numerous financial institutions, compare, contrast and synthesize all the information whereas the financial institution might have to set up several meetings gather information, learn about the prospective goals, objectives, experience, type of assets just to learn that the prospective client does not fit their criteria for a possible relationship. That manual process is tedious, cumbersome and unwieldy because the prospective client has to analyze, synthesize and understand all information which is not always presented in a concise, straightforward, easy to understand format and method and the financial institution would have to maintain a staff of sales people or new business development officers to meet with each prospective client and the institution would have to maintain a staff to review, analyze, and respond to whether a prospective client was qualified and if the prospective client were qualified that financial institution would use a paper based manual process of screening, qualifying, approving and opening a prospect account and manually input all pertinent information manually sometimes several times to create a contact, qualified and set up form/account. Improvement to this procedure or method and process could stimulate competition for traditional trust financial products and services offered to these prospective clients.

In addition analyzing trust and asset transfer documents and other pertinent documents needed to open trust company type accounts can be timely and inefficient. A software computer product is needed to transfer information to the necessary checklists and account opening documents driven by policies, rules and procedures directed by compliance and regulatory authorities.

To facilitate understanding, the following discussion will be directed to the specific example of a prospective trust client, e.g., a trustor, trustee, executor or executrix, prospective investment management client or the like, and a financial institution, e.g., a state or federal bank, independent trust company, credit union or credit union service organization, or the like. However, this can also apply to a financial institution searching for a trust vendor as defined above and shall apply throughout this non-provisional application.

When a prospective trust client needs a traditional trust product or service it may obtain them from a financial institution. The prospective trust client or their professional team (accountant, lawyer or other advisors) usually have a self interest or fiduciary duty to either beneficiaries of the trust or estate or their respective clients or family members, so it must ensure that it obtains the best traditional trust or investment management products and services. To do this, the prospective trust client or their professional team usually set up several meetings, deals with a number of different financial institution personnel or contacts several financial institutions. The sales person or new business development person for the financial institution at these meetings describes the type of financial products or services offered and recommends and gathers information needed and requests that their respective trust committees approve as a qualified prospect usually over a period of time. This process is repeated sometimes with a number of financial institutions. All financial institutions that gather information and receive information from sales person or new business development officer received by that date certain are reviewed by the financial institution, and it is determined if prospective client is qualified and if so if all assets are acceptable to financial institution. Several meetings among all parties and a paper based manual process from gathering information, disseminating information among committee members. This procedure, method or process is, not only, inefficient, in both time and money, it may not provide the prospective trust client with the “best” information regarding products and services that would be available, if this procedure or process was more open and available to a broader market.

Once the background information and predetermined criteria is reviewed and discussed by each potential client it must be determined if an existing trust document already exists or if one needs to be drafted an executed. Several legal documents from trust agreements, side agreements, documents that pertain to assets being transferred to or from a trust or similar account and other similar documents need to be reviewed. This information then needs to be analyzed by filling out more checklists, distribution forms, summary's of all the documents and other forms as either mandated by a compliance or regulatory authority or legal or other trust department. All the same time and constraints apply to this analysis, review and form filling out applies.

To better understand this process, method or system procedure, lets consider the participants of the prospective client and the financial institution. The prospective client typically has an accountant, lawyer, other team of advisors or individual fiduciaries or family members which work with and also advise prospective trust client, beneficiaries and their family members. The accountant or attorney, power of attorney, family member might be responsible for obtaining information or recommending to prospective clients a financial institution, reviewing all the various pieces of information, and making a recommendation about which financial institution is “best.” The financial institution typically has a sales person or new business development officer, administrator, administrative assistant, investment management consultant, relationship manager and a trust committee that ultimately approves qualified accounts. The relationship manager ensures that the prospective client receives a sound level of service and that the relationship is enhanced by the financial institution's opportunity to serve. The trust committee assesses the soundness of the assets and client, legal documents and history with the account or prospective client and the product and services offered to the prospective client, and ensures that the institution receives adequate compensation for amount of risk being taken based on the products and services offered. The sales or new business development person ensures that all information is gathered and to explain to prospective client all pertinent information related to the financial institution.

The Trust Counsel or other in house legal team ensures that the trust agreements and other related documents are reviewed and that more checklists and forms are filled out as driven by compliance and regulatory polices, rules and procedures. This can take even longer to complete then the referral, matching and tracking process as described herein.

This process or system procedure is slow and inefficient. For example, it is generally paper-based and document intensive. On the prospective client, it requires traveling to several financial institution, conducting several meetings sometimes with the same financial institution, responding or having the financial institution contact by writing or telephone, receiving and answering questions from each financial institution, waiting for every trust committee member to approve account, creating a comparative outline for gathering, analyzing and synthesizing all the information, possibly having professional team member or advisor, fiduciary trustor, executor or power of attorney sharing findings and recommendations to other beneficiaries, family members or other professional team members, and then notifying the financial institution which one has won the business. On the financial institution side, it requires hiring a sales person or team or new business development officer to handle the initial meeting(s) to learn about each other and gather the information, providing the sales person with background history and current and future financial information about the prospective client, soliciting questions and answers from the prospective client or their team of advisor's, analyzing the prospective clients needs and investable assets, researching prior history with other investment managers or trustees or executors, having trust committee agree to accept prospective client after a long manual process or procedure to approve through a paper based tedious information input and transfer, presenting that recommendation to prospective client and waiting for a response from prospective client, obtaining possibly beneficiaries or individual fiduciaries or soliciting professional team members or other family members input for approval through justification of both pricing, performance, and people within the financial institution, coming to final agreement on whether prospective client will open account and whether financial institution will accept prospective client, administrator and or administrative assistant inputting all contact information and re-typing the same information onto a qualified contact sheet for trust committee approval along with typing additional information when account is finally approved and an account set up needs to be created, mailing out follow up letters and or acceptance of trust business. This procedure can often take as many as several weeks to several months for a prospective trust client and their advisors to be able to source a financial institution, and learning, educating, comparing and contrast all the various financial institutions are so complex that some prospective clients wait or delay or never even undertake this process or procedure, or do so only infrequently (e.g., every three to five years). Further, because this process or procedure is so tedious, cumbersome and unwieldy it is undertaken so infrequently even if prospective trust client would like to make a change of trust company's or financial institution, the prospective trust client has to relearn the process or procedure each time, thereby wasting time and further slowing the process to transfer their respective accounts or open an account.

The same applies for in house staff reviewing documents and filling out forms, checklists, summary's and trying to obtain and track information that is necessary to properly open accounts based on policies, rules and procedures dictated by regulatory financial authorities.

The procedure or process for obtaining clients through marketing, advertising, word of mouth, hiring and training personnel to screen and determine if a prospective client is qualified and have administrative personnel perform paper manual procedures to open accounts, is expensive. For example, the traditional trust company or financial institution business model used for tracking internal or external referrals, made by i.e., professionals (accountants, attorneys, insurance agents, real estate agents, title insurance company agents), employees of financial institutions (sales person or new business development officer and other bank or trust personnel), an administrator, assistant administrative and a market executive for each prospective account and for each request made by a prospective client. This process or method is expensive because of the staff needed for the tracking of referrals and entire account opening process, as well as, the interaction required to execute an agreement and transfer the account.

It is also extremely costly to hire in house counsel after reviewing trust and asset documents and other legal documents to then have to transfer and or fill out checklists, distribution lists, summary's and other forms necessary to do due diligence or to stay in compliance with trust banking rules, regulations and procedures from a manual more traditional way. Having trust staff track and follow up on missing trust information, background information, asset transfer information, other trust documents or agreements and other legal documents or information manually and in paper based form is very timely, costly and extremely inefficient.

Furthermore, the traditional trust company model for the prospective client continues to be even more expensive in other ways. The higher costs are due to several factors. First, the length of time it takes for the gathering of information, frequency of meetings to facilitate an account opening and transfer of assets, to the financial institution especially the time and energy it takes the prospective client to interview all financial institutions which require a learning curve for each new financial institution that is visited. Second, this might warrant a dedicated group or team of advisors or other family members to gather information on all financial institutions in a cumbersome, tedious and unwieldy manner. Third, Lastly, additional legal considerations to the credit decision, thus requiring higher-than-ordinary legal counseling and advice. Additional time reviewing forms, summary's, checklists, trust documents, setting up manually ticklers and reviewing other legal documents that would otherwise not be necessary if a software computer program process, procedure and system were in place which used a non-traditional methods as described in the claims above.

The older more traditional procedure provides no economies of scale for either the prospective trust client or the financial institution. For example, prospective trust clients are often presented with gathering information on a limited number of financial institutions because it is often too tedious and cumbersome and when the financial institutions receives a referral internally or externally, keeping track of incentive fees, is not dealt with efficiency, especially when the size of such deals may not be large enough to justify much time and energy being devoted to the process. Further, due to the limited staffing common with most smaller financial institutions, the administrator or their assistant or new business development officer tends to take on many different roles and is burdened with a workload that often distracts him from one of his direct responsibilities, namely, gathering information regarding assets, goals, objectives, discussing the financial institution background, determining if prospective client is qualified and approving and opening and then transferring account.

In house legal counsel or trust counsel must constantly fill out more and more forms manually, make constant updates manually ever time a new pieces of legal information is presented, set up manual ticklers for certain critical dates, events or happenings.

Accordingly, there is a need to improve the process, method and system for matching, referring, tracking, reviewing documents and filling out all account opening documents for traditional trust services and products with financial institutions as mandated by their policies, procedures and rules driven by compliance and regulatory mandates.

### SUMMARY OF THE INVENTI N

The present invention is directed to a method, process and system for a prospective trust client, trustor, trustee, executor, prospective investment management client to facilitate the match, referral, approval, tracking and transfer for account opening for traditional trust products and services between financial institution and prospective trust client and financial institution and trust vendor(s). The method includes the steps of: matching prospective trust clients who seek a new or changed relationship with a financial institution for traditional trust products and services to a website, the match being facilitated by criteria supplied by both parties having been initiated by prospective client and authorized by financial institutions trust committee; electronically notifying the financial institution that a match occurred and the contact form and background information has been transmitted; reviewing the contact form and background information by the financial institution; and electronically notifying the prospective client that additional information is needed as a result of the review by the financial institution to create an approval form and if accepted to an account set up. Electronically notifying the person, company or professional group that referred prospective client and keeping track of referral fee and the transfer of assets to open and fund account. Analyzing trust and other legal documents to facilitate the opening of the account and filling out all pertinent forms as driven by regulatory policies and compliance rules and procedures. The above process applies similar to a financial institution searching for a trust vendor with the same process and system as for a prospective trust client and financial institution.

### BRIEF DESCRIPTION OF THE APPENDED DRAWINGS

Having thus described the invention in general terms, reference will now be made to the accompanying FIGS. 1A-R, and wherein:

FIG. 1 (is better understood and appreciated by persons skilled in the field to which the invention pertains in view of the following description given in conjunction with the accompanying drawings which illustrate preferred embodiments.) is an example or illustrates exemplary steps of a referral agreement between referring provider and other potential client or financial institution and potential client acknowledgement agreement of the (A) referral agreement between referring provider and other potential client or financial institutional and potential client and agreement signed by potential client acknowledging referral arrangement; (B) database of potential clients, (C) contact forms with predetermined criteria, (D) background information, (E) Temporary Trust Agreement (F) trust document terms and other forms of information for the process, method or referral, matching, approval and account opening back-end or front-end system of one embodiment of the present invention showing the relationship between the referral agreement, contact forms, predetermined criteria, background information trust document terms and other forms, another potential client and computer and a plurality of backend systems and (G) tickler system for the referral, matching, approval and account opening system; (H) screen shot of a start page of a graphical user interface of another embodiment of the present invention; (I) screen shot of a database directory page of the graphical user interface; (J) screen shot of contact page of the graphical user interface; (K) a screen shot of a referral page of the graphical user interface; (L) a screen shot of an account-type page of the graphical user interface; (M) a screen shot of a service charge page of the graphical user interface; (N) a screen shot of a pickup information page of the graphical user interface; (O) a screen shot of a billing information page of the graphical user interface; (P) a screen shot of an account information page of the graphical user interface; (Q) a screen shot of an account number provision page of the graphical user interface of the present invention; (R) account information management table stored in a virtual account management information user interface useful for gathering information according to the present invention.

### DETAILED DESCRIPTION OF THE PREFERRED EMBODIMENTS

Hereinafter, the preferred embodiment of the present invention will be described in reference to FIGS. 1A-R. FIGS. 1A-R attached having same functions in the following description.

### Description of the Invention

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Intended to be implemented via a website method of facilitating matching, referral, approval and tracking traditional trust products and services as well as trust vendor products and services for financial institutions as a web-based solution to the above-mentioned problem. The website is preferably a secure website, so that privacy of the member is maintained. Members or other potential clients, e.g., independent trust companies, state and federal trust banks, credit unions, credit union service organizations or other financial institutions, trust vendors (e.g., systems, software, hardware, research, custody, brokerage, etc.) and prospective trust clients/potential clients (e.g., powers of attorney, attorney's of client, accountants of client, other similar type of agents, trustor(s), trustee(s), beneficiaries, executor(s), investment management client(s) would access the system, process, method by logging onto the website. When the members identify themselves at the website, the member may receive messages, which are only retrievable by logging on.

Each member shall preferably have a profile (predetermined criteria and or background information). The profile contains standard information about the member including, but not limited to, name, address, contact information, key individuals, organizational structure, historical data (e.g., performance, size of company or department, assets under management, product pricing, trend financial summary, previous experience, types of accounts). The member shall have the ability to periodically review and update and information in the profile. The profile may also contain preferential information about the member including, but not limited to, referring individual, company or professional organization, other relationships with the financial institution or other relationships that will be created.

The method is usually initiated by the prospective trust client or in the case of a financial institution seeking a trust vendor the financial institution. The prospective client or member, after logging on and, if necessary reviewing and modifying their profile, selects the financial institution from a serious of criteria determined by asking and answering several questions (discussed below). Selection may be facilitated by “drop down buttons” that provide different choices. Each match will have a “contact form”. The contact form outlines, at least, a minimum amount of information that the financial institution shall require to evaluate the prospective trust client. Some of that information may be available from the member or prospective client's background information or profile and could be automatically entered onto the contact form. Other information would have to be entered by the prospective client onto a qualified form. After completion of the additional information it is electronically sent onto a qualified form, and reviewed by financial institution trust committee. It is contemplated that completion of the final account opening form can also be accomplished with the supply of additional information and send electronically to financial institution.

The prospective trust client may then select up to a total of five matches which financial institutions that it wishes to receive their contact and background information so they can determine if prospective client is qualified. This would equally apply to a financial institution gathering information from a trust vendor.

The financial institution logs onto the website retrieves the contact form and background information and begins to review the prospective client to determine if they are qualified. If after the initial review the financial institution believes that further information is needed to fully evaluate and respond to the prospective client, it may solicit such additional information. The institution prepares the questions and preferably submits them to the prospective client via the website. Once the questions are at the website, the prospective client is notified. The prospective client responds to the questions, preferably via the website. This information is either electronically sent over or can be accessed by the financial institution logging onto the website and retrieving the qualified form.

The financial institution creates their proposal and acceptance of prospective client. After completion of the proposal or approves account, which the financial institution does pursuant to its internal procedures, typically the trust committee. Thereafter, the proposal or acceptance is preferably released to the website.

At the website, the various proposals or acceptances from several financial institutions are preferably assembled in a format to facilitate the prospective client's review and selection of the various proposals or acceptance. The assembled proposals or acceptance, are presented to the prospective client.

The prospective client selects the “best” proposal or acceptance, pursuant to discussions with their family members and other professional team of advisor's. The winner is notified preferably via the website.

Once approved by both parties (prospective client/potential client and financial institution/other potential client) and after trust document and other legal documents along with asset review and all forms as it relates to those documents have been filled out then completion of the account opening form and documents, a notification is sent to the referring party, specifically, the transfer or funding of account has begun. After assets are transferred or fund account referring person, individual, company or professional group or organization receive referral fee. That official from financial institution reviews and authorizes payment to referring party before its released to referring party.

A notification is sent to prospective client. The notification informs the prospective client that the account has been accepted, opened, assets have been transferred and referring party has received a fee for the referral but has not increased product/service pricing. Status updates are available for retrieval at the website. The Referring Party preferably, is not sent directly to the financial institution or prospective client after approval and funding or transferring of assets to account, but instead, it is tracked and facilitated through the website.

Again it shall be noted that the above will also apply in the same manner for a financial institution and trust vendor.

### Background on Traditional Process

Call comes into financial institution by prospective client or a call from an internal or external referring party regarding a prospective client. Administrator or their assistant contacts prospect client or contacts sales person or new business development officer to contact prospective client. Sometimes the prospective client is contacted the same day or several days later from original call. If an external referring party makes the introduction to the prospective client that referring party must be contacted to acknowledge referral and get some general information. New Business Development officer meets with prospective client. New Business Development Officer gathers information from client to prepare contact or information sheet. Sometimes prospective client does not bring all information at the time of the initial meeting and another meeting is then set up. Other parties need to be involved in the discussion or meeting e.g. accountants, attorney's, beneficiaries, other family members etc. Administrator or their assistant or relationship manager sends out a letter(s) regarding initial meeting to all relevant parties to discussion or meeting. Another meeting is subsequently set up sometimes several weeks or months after the original meeting. Financial institution makes several calls to prospective client asking for additional information and trying to determine if client is qualified and if client is interested in opening an account.

Traditional Process has relationship manager or sales person following up with more letters, calls and meetings. Every member of the trust committee must look at the contact form, background information, legal documents, history of account and prospective client and sign off. Legal documents need to be reviewed, analyzed, synthesized and more forms such as checklists, ticklers, distribution lists, summary's and other forms need to be filled out. This process traditionally has paper work being sent throughout the department or committee with each trust committee member approving the account individually. Sales or Relationship Manager Officer analyzes all information makes all appropriate contacts and assesses the opportunity all financial data agreements and paperwork prepares contact, qualified and set up account forms. Sales or Relationship Manager Officer evaluates investable assets, where the funds are located or will be transferred from, need for income or cash flow, this financial institution Officer evaluates or does a performance analysis on current investment management or trust account by looking at current financial statement, legal and other documents are reviewed along with any notes, Officer makes recommendation to accept business and sends data to trust committee to review all information and documents; proposal is created or pricing acceptance are made, upon acceptance of prospective client, agreements are signed and internal or external referring party are notified that an account has been opened; referral fees are paid either a one time flat fee, monthly, quarterly or annual fee, these referral fees must be tracked by administration or their assistants, sometimes over one year, several years or throughout the relationship with the prospective client;

### Proposal Evaluation and Selection

Traditional Process for prospective clients is to contact several financial institutions and set up several meetings with different financial institutions sometimes with the same financial institution; compare product and service pricing, performance and quality of staff and experience, each acceptance by financial institution can be analyzed, and recommendations can be made by professional advisors or family members or beneficiaries. Notify financial institution that account will be opened and financial institution must notify prior financial institution, brokerage house, insurance company, financial planner etc. that assets are being transferred (sometimes this process could take four to several months time). This process is very slow and can require considerable follow up with no uniformity among institutions assets are being transferred from.

Trust products and services, as used herein, may refer to many different types of trust products or services, e.g. prospective trust client and financial institution, or trust vendor financial institution or financial institution to financial institution (outsourcing) trust products and services may include: investment products (stocks, bonds, mutual funds, money market funds or other investment products that might be held by a financial institution), trustee products (revocable, charitable, irrevocable, insurance or any other type of trust), employee retirement products (401(k), 403(b), Roth, SEP, Simple or traditional IRA's, 529 plans, pensions or any other type of retirement plan), advisory products as it relates to trust vendors or financial institutions or prospective clients (custody, concierge, brokerage, consulting to mutual find companies or employers, education, sales, marketing or other outsourcing services to financial institutions), estates, or any other product or service that can be conducted by a financial institution with trust powers. Advisory products refer to trust vendor products in which a financial institution seeks advise on decisions and/or options related to selection, evaluation, execution of, trust, estate or investment management products and services. In summary, this process is applicable to any type of trust product or service offered by financial institution with trust powers, where the financial institution performance, staff, pricing and products and investment philosophy and style must be outlined, prospective client information must be assessed, and financial institution offerings must be compared and selected. For this reason, it should be obvious that the process method and system of the present invention could be applied to other trust products and services not specifically mentioned herein.

There are many different types of trust products and services. Each trust agreement and related legal documents and potential client pre-determined criteria and background information can be quite different. Thus a paper intensive focus can make this process and traditional method much more costly, timely, inefficient and ineffective from a productivity and business prospective. This software application computer process, method and system is essential for these potential clients and other potential clients similiarly situated to increase productivity, save time and money and stream line office practices and procedures that are driven by compliance and regulatory authorities.

What is claimed is:

1) A software computer application program product whose process or method is directed toward individuals, for profit businesses, non-profit charities, municipalities, family offices, state and federally chartered trust bank departments, independent trust companies and private trust companies, credit unions, credit union service organizations, registered investment advisory groups, trust vendors, trust & estate attorney's, accountants, accounting firms or other similar clients, hereinafter “potential clients” or “other potential client” as each potential client can be a potential client of the other, to perform a first process or method of administration, screening, matching, referring and account opening of a potential client with other potential clients for the benefit of each potential client via a website where each potential client is performing a second process or method, the software computer application program product comprising the following steps:
a website computer storage or recording medium device readable through inputs by potential clients by a computer and website; and
the inputed instructions stored on website computer storage or recording medium device instructing the computer through a website to perform the first process or method, the software computer application program instructions and the first and second processes or methods including:
(a) receiving, from potential clients, to screen and match with other potential clients or administer in accordance with background information, predetermined criteria and other criteria; (price, experience, staff, performance, technology) (name, address, email, telephone number, investment experience, risk tolerance, type of investable assets, type of account, etc.) and criteria (price or fees to be paid, experience of trust company or financial institution, location (number of branches or physical locations), staff (size, assets under management, experience performance, technology (maintained internal or use of vendors or outsourced, custody or use of third parties) to be matched with a trust company or financial institution. Likewise a financial institution can seek a trust vendor in a similar fashion. (type of instituion (state bank, federal bank, independent trust company, credit union, credit union service organization or other financial institution), regulator (OCC, OTS, NCUA, Federal Reserve Board, FDIC, state banking department or some other banking regulatory body), types of accounts that are handled, years in business, description of staff and their respective experiences and backgrounds, performance (AIMR compliant or not AIMR compliant, audited or un-audited performance, 1, 3, 5 or 10 year performance record), size of portfolio's accepted, types of assets held or not held (for example, real estate, closely held stock or businesses, limited partnerships etc.) and other criteria similar to the prospective client. client (account size, net worth, total relationships, types of assets etc.).
This also applies to financial institution searching for a trust vendor and whose process, method and similar works in the same manner.
(b) storing, by a website computer storage or other similar type of recording medium device, potential customer related data associated with the potential customer;
(c) Notification, receiving and acknowledging, by the potential client, with the use and assistance of the website, confirmation of the background information, predetermined criteria or other criteria from potential client, where software computer application program product enters this information and criteria into potential client computer for administration;
(d) appointing, by potential clients, a customer, financial institution, professional organization or vendor to adminster and manage the background information, criteria that was screened and matched;
(e) administration, by potential clients with the assistance of the computer, computer website and software computer application software program product, after matching and screening occurs of all information potential clients are given up to five names of other potential clients.
(f) tracking information as a result of the screening and matching; financial institution reviews the potential clients background information and criteria; and electronically notifying potential client once financial institution sees the results and reviews background information and criteria.
(g) determining, by potential clients after reviewing background information, critera and screening and matching whether a potential client is acceptable to the other potential client based on inputed criteria and background information;
(h) rejecting, by potential clients with the assistance of the computer, website and computer software application when background and criteria do not match, and returning to step (g), wherein at least one of the potential clients meets screening and matching background and criteria;
(h) transmitting data, by a potential client to another potential client with the assistance of the computer, website and software application computer program product of all the information necessary to establish an account opening contact form;
(i) requesting by potential client of the other potential client further information to facilitate further opening an account such as but not limited to: trust terms or trust document, investment management terms, estate and financial planning terms, transfer of asset instruction or assignments and other documents necessary to open trust, guardianship, investment management, custody or other type of trust company type accounts;
(j) more detailed information “other information” (risk criteria, experience, preferred asset allocation, length of time, income needs or re-invest income, cash or in-kind transfer, cost basis, trust agreements, account opening documents, such as but not limited to: partnership, LLC or corporation agreements, assignment and admission documents, asset statements, or notes and mortgages in trust account or other similar assets;
(k) transmitting data, by at least one potential client to another potential client with the assistance of the computer, website and software application computer program product of all the information necessary to establish a terms of trust account, account opening documents and compliance with state or federal trust regulatory rules, policies and procedures;
(l) transmitting data, by at least one potential client to another potential client with the assistance of the computer, website and software application computer program product with the predetermined criteria and other criteria as set forth above herein to a potential client from another potential client when after administering, matching, screening and setting up an account and at least one potential client has opened an account with another potential client when the predetermined criteria and other information has been obtained, analyzed and used to open an account for potential client in compliance with the policies, rules and procedures of potential client and regulatory institution.

2) A software computer application program product whose process or method is directed toward individuals, for profit businesses, non-profit charities, municipalities, family offices, state and federally chartered trust bank departments, independent trust companies and private trust companies, credit unions, credit union service organizations, registered investment advisory groups, trust vendors, trust & estate attorney's, accountants, accounting firms or other similar clients, hereinafter “potential clients” or “other potential client” as each potential client can be a potential client of the other, to perform a first process or method of administration, screening, matching, referring and account opening, of a potential client with other potential clients for the benefit of each potential client via a website where each potential client is performing a second process or method, the software computer application program product comprising the following steps:
a website computer storage or recording medium device readable through inputs by potential clients by a computer and website; and
the inputed instructions stored on website computer storage or recording medium device instructing the computer through a website to perform the first process or method, the software computer application program instructions and the first and second processes or methods including:
(a) receiving a request from potential clients to administer the screening, matching and referral based on the background information, predetermined criteria and other criteria as set out in claim 1 above.
(b) storing potential clients related data associated with the other potential client;
(c) at least one of Notification, receiving and acknowledging by the other potential client, background information, pre-determined criteria or other criteria needed to administer, match, screen and open an account;
(d) determining the background information, criteria that was screened and matched to open an account;
(e) administration, matching, screening and transferring information to proper account opening forms for at least one potential client until predetermined period of time and until occurrence of a predetermined event;
(f) tracking information of the background information, predetermined criteria and other information to screening, match and refer to potential clients;
(g) determining whether a potential client is acceptable to the other potential client based based on inputed criteria, background information, trust and investment management terms other terms and other documents;
(h) rejecting by a potential client when based on initial background and criteria does not match and when the trust or investement management terms is not approved or accepted to be changed by potential client during the screening and administration process and method in accordance with claim 1 has occurred and returning to step (e);
(h) transmitting data to a potential client when the initial administration, screening, information gathering and matching is still in process; and
(i) requesting by potential client of the other potential client further information to facilitate further opening an account such as but not limited to: trust terms or trust documents, investment management terms, estate and financial planning terms, transfer of asset instructions or assignment of assets and other documents necessary to open trust, guardianship, investment management, custody or other type of trust company type accounts;
(j)further requesting more detailed information “other information” from potential client (risk criteria, experience, preferred asset allocation, length of time, income needs or reinvest income, cash or in-kind transfer, cost basis, account opening documents, such as but not limited to: partnership, LLC or corporation agreements, assignment and admission documents, asset statements, or notes and mortgages in trust account or other similar assets;
(k) transmitting data, by at least one potential client to another potential client during the open and accepting process of any trust company type of an account
(l) transmitting data to at least one potential client from another potential client after the predetermined criteria, background and other information has been accepted and processed and when and account has been opened an account where the potential client is in compliance with the potential clients policies, rules and procedures as it relates to opening accounts further based on regulatory practices.

3) A software computer application program product whose process or method is directed toward individuals, for profit businesses, non-profit charities, municipalities, family offices, state and federally chartered trust bank departments, independent trust companies and private trust companies, credit unions, credit union service organizations, registered investment advisory groups, trust vendors, trust & estate attorney's, accountants, accounting firms or other similar clients, hereinafter “potential clients” or “other potential client” as each potential client can be a potential client of the other, to perform a first process or method of administration, screening, matching, referring and account opening, of a potential client with other potential clients for the benefit of each potential client via a website where each potential client is performing a second process or method, the software computer application program product comprising the following steps:
a website computer storage or recording medium device readable through inputs by potential clients by a computer and website; and
the inputed instructions stored on website computer storage or recording medium device instructing the computer through a website to perform the first process or method, the software computer application program instructions and the first and second processes or methods including:
(a) means for establishing by either a potential client, a database or directory of potential clients, a network of plurality of approved potential clients and/or providers;
(b) Submitting, by a provider and/or potential client, an application and/or referral fee and/or a referral agreement to join the network of approved providers;
(c) Providing, by provider to potential client, documents and information necessary to enter into a referral arrangement and documents and information necessary to open any type of trust company account;
(d) Receiving, by a potential client, a request from another potential client to administer the background information, predetermined criteria and other information in accordance with account opening processes and procedures established by potential clients and regulated by certain state or federal banking or trust authorities;
(e) Preparing, by either the provider and/or potential client for the other potential clients with assistance from the software computer application program product, a referral agreement and schedules to comply with state and federal regulatory banking and trust laws, rules, procedures and policies as Schedules to referral agreement, trust agreement and other relevant documents such as appointments, assignments of assets, list of and statement of assets, background information on potential client, predetermined criteria;
(f) Storing, by a website computer storage or recording medium device, potential client related data associated with potential clients;
(g) Determining, by at least one of the potential clients and the website and/or computer, by the other potential client with the assistance of the and/or provider with the assistance of a website and/or computer, receipt of documents, background information and criteria from potential client, and entering the documents, background information, criteria and all account opening forms necessary to open any type of trust company type account into the website and/or computer for administration;
(h) administering, by the potential client with assistance from the website and/or computer, tracking, matching, screening and transferring information to their proper account opening documents based on predetermined criteria, background information and policies, rules and procedures of potential client and regulatory body over-seeing potential client making sure that the predetermined criteria, background information and rules, policies and procedures are adhered to before accepting a new account and ensuring that all predetermined criteria, background information, documents requested are not prematurely diverted, and preventing a account from being opened based on the pre-determined criteria, background information, documents and policies, rules and procedures of potential client from being compromised.
(i) Tracking the various potential client catergories such as individual clients, company clients, Independent Trust Company, Federal Trust Bank, State Trust Bank, Credit Union and Credit Union Service Organization, lawyers, accountants, family offices, registered investment advisors and other similar types of potential clients as it relates to the predetermined criteria, terms of trust and transfer of asset resources;
(j) Transmitting, by at least one of the potential clients to the other potential client with the assistance of the computer and or website, details of the administration of the predetermined criteria, terms, trust terms and transfer of assets to at least one potential client and the other potential client/customer;
(k) Requesting, by the potential client, to at least one other potential client and the other potential client/customer to input terms, trust and asset documents and or terms and predetermined criteria;
(l) Determining, by at least one of the potential clients and the other potential clients with the assistance of the computer and or website, whether an account would be open.

4) A computer program product in accordance with claim 2, wherein the rejecting (h) instruction prevents a referral to be given an account from being opened until acceptance in (e) in accordance with claim 2 occurs.

5) A computer implemented process, method or system instructing and implemented by a computer to perform a process, method or system of administering or assisting in a program for the administration of pre-determined criteria, background information, other information, trust terms and other legal terms of a potential client for the benefit of the other potential client, according to claim 3, wherein at least one potential client or provider, transmits a copy of the fully executed account opening documents, trust agreement, summary, checklists, ticklers and any other information or additional authorizations used to open account used by potential client and or signed by other potential clients and notifications given of successful opening of account.

6) A computer implemented process, method or system instructing and implemented by a computer to perform a process, method or system of administering or assisting in a program for the administration of pre-determined criteria, background information, other information, trust terms and other legal terms of a potential client for the benefit of the other potential client, according to claim 3, wherein at least one of the sequential, non-sequential and sequence independent steps have taken place.

7) A software computer application program product whose process or method is directed toward individuals, for profit businesses, non-profit charities, municipalities, family offices, state and federally chartered trust bank departments, independent trust companies and private trust companies, credit unions, credit union service organizations, registered investment advisory groups, trust vendors, trust & estate attorney's, accountants, accounting firms or other similar clients, hereinafter “potential clients” or “other potential client” as each potential client can be a potential client of the other, to perform a first process or method of administration, screening, matching, referring and account opening, of a potential client with other potential clients for the benefit of each potential client via a website where each potential client is performing a second process or method, the software computer application program product comprising the following steps:
a website computer storage or recording medium device readable through inputs by potential clients by a computer and website; and
the inputed instructions stored on website computer storage or recording medium device instructing the computer through a website to perform the first process or method, the software computer application program instructions and the first and second processes or methods including:
(a) establishing by either a potential client, a database or directory of potential clients, a network of approved potential clients and/or providers;
(b) Submitting, by a provider and/or potential client, an application and/or referral fee and/or a referral agreement to join the network of approved providers;
(c) Providing, by provider to potential client, documents and information necessary to enter into a referral arrangement and documents and information necessary to open any type of trust company account;
(d) Receiving, by a potential client, a request from another potential client to administer the background information, predetermined criteria and other information in accordance with account opening processes and procedures established by potential clients and regulated by certain state or federal banking or trust authorities;
(e) Preparing, by either the provider and/or potential client for the other potential clients with assistance from the software computer application program product, a referral agreement and schedules to comply with state and federal regulatory banking and trust laws, rules, procedures and policies as Schedules to referral agreement, trust agreement and other relevant documents such as appointments, assignments of assets, list of and statement of assets, background information on potential client, predetermined criteria;
(f) Storing, by a website computer storage or recording medium device, potential client related data associated with potential clients;
(g) at least one of receiving and acknowledging, by the potential client with the assistance of the website and/or computer, receipt of the predetermined criteria, background information and trust agreement, terms and other information associated with opening any type of trust type account from the other potential client, and entering the pre-determined criteria, background information and trust terms into the website and/or computer for administration, referral, matching, screening and account opening;
(h) after full matching, screening appointing, by potential client, another potential client to administer and manage the account in the capacity as trustee, executor, investment manager or custodian;
(i) Determining, by at least one of receiving potential clients and acknowledging, by the potential client and/or provider with the assistance of a website and/or computer, receipt of documents, background information and criteria from potential client, and entering the documents, background information, criteria and all account opening forms necessary to open any type of trust company type account into the website and/or computer;
(j) administering, by the other potential client with the assistance of website and/or computer, the predetermined criteria, background information, trust documents, other documents including transferring all information to account opening documents after analyzing same until occurrence of a predetermined event, wherein the predetermined event, wherein the predetermined event enables a paperless website and or computer based account opening by screening, matching, referring potential clients with predetermined criteria and background information, documents analyzed inputed into website and/or computer;
(k) tracking all inputed data from documents, checklists of predetermined criteria created by potential client, background information and other information necessary to open an account;
(l) transmitting, by at least one of the potential clients and other potential clients with the assistance of the computer, details of the administration of the pre-determined critiera, background information, trust agreement terms and other legal information to fully open an account from potential client to other potential client;
(m) requesting by the potential client, to at least one of the other potential clients to make changes to trust agreement terms and other legal information;
(n) determining, by at least one potential client and the other potential client with the assistance of the computer, whether all trust terms and other legal information has been updated and transferred after the initial review and analysis period of time;
(o) rejecting some of the trust and other legal document terms and conditions, by at least one of the potential clients and or trustees with the assistance of the computer, the request of the potential client or other potential client during the pre-opening account period of time before all account, summary, checklists, ticklers and other pertinent forms have been completed or occurred, and returning to the administering step (f), wherein the potential client or trustee thereby will not open an account based on the pre-determined criteria, background information, terms of trust and or other legal documents necessary to open an account or other similar pertinent information necessary to open an account until such time as the opening documentation for an account based on the satisfaction of all information requested and reviewed, ensuring all the information is gathered, reviewed/analyzed and synthezied and information transferred to proper form which ensures that an account is not prematurely rejected which would prevent the information to open an account from being comprised;
(p) transmitting, by at least one of the potential clients and the other potential client or trustee with the assistance of the computer, where all information during the pre-opening period of time is given to potential client during the pre-opening of the account period of time; and
(q) transmitting, by at least one of the potential clients and the other potential clients or trustee with the assistance of the computer, in accordance with the predetermined criteria, background information, other information, trust and other legal terms to the potential client after an initial rejection and when at least one deadline to open an account has expired and the predetermined period of time has occurred.
